(19) United States
(12) Patent Application Publication
(10) Pub. No.: US 2017/0032586 A1
(43) Pub. Date: Feb. 2, 2017

(54) SYSTEMS AND METHODS FOR COLLABORATIVE VEHICLE TRACKING

(71) Applicant: Elwha LLC, Bellevue, WA (US)

(72) Inventors: Jesse R. Cheatham, III, Seattle, WA (US); Hon Wah Chin, Palo Alto, CA (US); William David Duncan, Mill Creek, WA (US); Roderick A. Hyde, Redmond, WA (US); Muriel Y. Ishikawa, Livermore, CA (US); Jordin T. Kare, San Jose, CA (US); Tony S. Pan, Bellevue, WA (US); Robert C. Petroski, Seattle, WA (US); Clarence T. Tegreene, Mercer Island, WA (US); David B. Tuckerman, Lafayette, CA (US); Yaroslav A. Urzhumov, Bellevue, WA (US); Thomas Allan Weaver, San Mateo, CA (US); Lowell L. Wood, JR., Bellevue, WA (US); Victoria Y.H. Wood, Livermore, CA (US)

(21) Appl. No.: 14/815,543

(22) Filed: Jul. 31, 2015

(51) Int. Cl. G07C 5/00; H04M 1/02; H04W 4/02; G01S 19/13

(52) U.S. Cl. CPC G07C 5/008; G01S 19/13; H04M 1/0202; H04W 4/02; B64C 39/024

(57) ABSTRACT

A system and associated methods of operation for tracking vehicles, such as automobiles, aircraft, boats, unmanned aerial vehicles, and drones. The system includes a communication interface for receiving measurements and observations of a sighting location for each of one or more vehicles from a plurality of independent observers, which may include both human observers and equipment, such as cameras, phones, telescopes, and other automated tracking devices. Upon receiving the location information, a processor associates one or more measurements with a selected vehicle and computes a location of the selected vehicle based on the measurements. In some instances, the processor may also determine a flight path of the selected vehicle based on the measurements.

If an Application Data Sheet (“ADS”) has been filed on the filing date of this application, it is incorporated by reference herein. Any applications claimed on the ADS for priority under 35 U.S.C. §§119, 120, 121, or 365(c), and any and all parent, grandparent, great-grandparent, etc., applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 U.S.C. §119(e) for provisional patent applications, for any and all parent, grandparent, great-grandparent, etc., applications of the Priority Application(s)).

### PRIORITY APPLICATIONS

None.

If the listings of applications provided herein are inconsistent with the listings provided via an ADS, it is the intent of the Applicants to claim priority to each application that appears in the Priority Applications section of the ADS and to each application that appears in the Priority Applications section of this application.

All subject matter of the Priority Applications and the Related Applications and of any and all parent, grandparent, great-grandparent, etc., applications of the Priority Applications and the Related Applications, including any priority claims, is incorporated herein by reference to the extent such subject matter is not inconsistent herewith.

### TECHNICAL FIELD

The field of the present disclosure relates generally to systems and methods for tracking vehicles, and in particular, to such systems and methods for tracking vehicle location based on human observations and other measurement data.

### SUMMARY

The present disclosure describes various embodiments of systems and methods for tracking vehicles, such as automobiles, aircraft, boats, unmanned aerial vehicles, and drones. As is further explained in detail below, the system may not only track a real-time location of vehicles, but may also determine a flight path that the vehicle has traveled along based on human observations and reported measurement data, which may be used to identify locations that the vehicle has visited, and may also develop a future or projected flight path to predict locations that the vehicle will visit.

In one embodiment, the system includes a communication interface configured to receive observations and measurements relating to vehicle locations from a plurality of independent observers, such as humans. The observations and measurements may include a variety of information relating to the vehicle, such as, for example, a location of the vehicle, a description of the vehicle, an estimated velocity of the vehicle, a direction of travel of the vehicle, and images or videos of the vehicle. The observations and measurements may also include information relating to the observer, such as a time and date of the vehicle sighting by the observer, a location of the observer, and identity of the observer. Upon receiving the information, the system attempts to identify a specific vehicle from a plurality of vehicles that the system may be tracking and associate the measurements with the specific vehicle. In addition, the system computes a location of the selected vehicle based on the measurements.

For example, in one embodiment, a first observer may report a sighting of a drone at 10:19 am near a downtown area, and also report the drone is traveling westbound at an unknown velocity. At 10:22 am, a second observer may capture a picture of a drone above a particular bank building in the western part of the city, and submit a picture of the drone and address information for the bank building. At 10:28 am, a third observer may take a snapshot of a drone flying westbound over a park and submit the snapshot via the communication interface. Finally, at 10:30 am, a fourth observer may report sighting a drone leaving the park, with no additional information.

Upon receiving the reports from these four independent observers, the system may first analyze the images received from the second and third observers and determine whether their respective drone reports relate to the same drone. Thereafter, the system may determine that the bank building identified by the second report is west of the downtown area where the first observer identified seeing the drone, which suggests that the first report likely relates to the same drone as described in the second and third reports. Finally, since the fourth report also locates the drone in the park (as did the third report), the system concludes that all four reports relate to the same drone.

With this data, the system may consider the general geography of the downtown area, the bank address information, the location of the park, and the time information of the reports to create a flight path that the drone may have traveled along between 10:19 a.m. and 10:30 a.m., and perhaps develop a projected flight path based on the velocity of the drone (as determined from the time of report submissions and the distance traveled) and other information, such as permitted flight corridors, restricted travel areas, and other suitable data. Throughout the day, the system may receive additional information from other observers that the system may determine relate to this drone. With this additional information, the system may adjust the projected flight path of this drone, or update other data that the system did not previously have for this drone. Additional details of these and other embodiments are described below with reference to the figures.

In other embodiments, the system may not only use information from human observers, but may also rely on information obtained by automated equipment and devices. For example, the communication interface may be linked to surveillance camera and satellite feeds to receive images, videos, radar measurements, GPS coordinates, and/or other data from the equipment. Since the equipment is not prone to human measurement error and may be able to provide location information with more precision (e.g., latitude and longitude coordinates), the system may be able to more reliably track vehicles by combining information from human observers with information from equipment.

In another embodiment, the system may further track the identity of the human observers and provide rewards or other incentives, such as money, lottery entry, and awards to help incentivize the general public to continue submitting reports. The rewards may be based on any one or more of the following: the quality of the observation and/or data provided, the number and frequency of reports provided, and the importance of the vehicle being tracked.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a plurality of observers coordinating information to determine the location of a drone.

FIG. 2 is a schematic diagram of an embodiment of a system for tracking a location of a drone based on information received from one or more observers.

FIG. 3 is a schematic diagram of an embodiment of a wireless communication device for tracking a location of a drone based on information received from one or more observers.

FIG. 4 is a flow diagram of a method for determining the location of a drone based on information received from one or more observers.

### DETAILED DESCRIPTION OF EXAMPLE EMBODIMENTS

With reference to the drawings, this section describes particular embodiments of various safety systems and their detailed construction and operation. Throughout the specification, reference to “one embodiment,” “an embodiment,” or “some embodiments” means that a particular described feature, structure, or characteristic may be included in at least one embodiment of the safety system. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

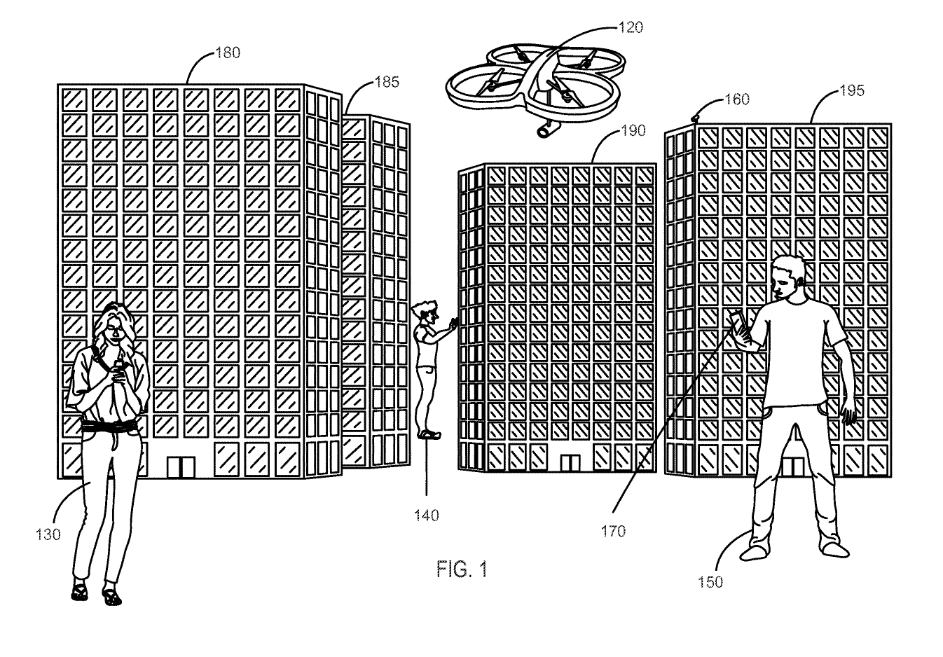

FIGS. 1-4 collectively illustrate various embodiments of a processing system 200 for tracking vehicles, such as automobiles, aircraft, boats, unmanned aerial vehicles, and drones. The processing system 200 includes a communication interface 210 configured to receive measurements and observations relating to a location of a vehicle 120 from a plurality of independent observers, which may include both human observers 130, 140, 150 and equipment 160, such as traffic cameras, surveillance cameras, mobile phones, telescopes, and other devices. Upon receiving the location information, a processor 220 analyzes the information and associates one or more measurements with a specific vehicle from a set of vehicles that may be stored in a database or memory unit of the processing system 200. For the specific vehicle, the processor 220 computes a location based on the measurements and observations. As is further detailed below, in addition to computing a location of the vehicle 120, the processor 220 may also determine other information relating to the vehicle 120, such as a past travel route or flight path or a projected travel route, based on the measurements. In addition, the processor 220 may track observer information (e.g., identity, account name, location, report accuracy, etc.) to incentivize observers so that the observers continue submitting reports. The following description provides additional details and examples of these and other embodiments of the processing system 200.

FIG. 1 is a perspective view illustrating an embodiment for tracking a location of a vehicle 120 using collective information received from one or more observers 130, 140, 150. In FIG. 1, the vehicle 120 is illustrated as an unmanned aerial vehicle or a drone, but in other embodiments, the vehicle 120 may be a manned aerial vehicle, a manned or unmanned ground vehicle, a marine vessel, a remotely piloted vehicle, or any other vehicle capable of moving from one location to another. For convenience, the description of the processing system 200 and the accompany figures proceeds with reference to tracking a drone 120. However, it should be understood that this convention is used for illustration purposes only and is not intended to limit application or use of the system 100 to tracking drones 120.

With reference to FIG. 1, the drone 120 may be spotted traveling along a route by a plurality of observers 130, 140, 150. Because the observers 130, 140, 150 may be standing in different positions relative to the drone 120, each of the observers 130, 140, 150 may provide unique information to the processing system 200 based on their individual observations and perspectives to help the processing system 200 locate and track the drone 120. While some observers 130, 140, 150 may only be able to provide partial observations and information relating to the drone 120 (e.g., location, speed, direction of motion/travel, identity), the processing system 200 may aggregate the partial information from a plurality of independent sources and use the collective information to determine various characteristics, such as location, travel path, and direction of travel of the drone 120. The following section describes a brief example of a method for tracking and locating a drone 120 using information submitting by observers 130, 140, 150.

With reference to FIG. 1, the first observer 130 may be standing close to a building 180 where she has a partially obscured view of the drone 120. Accordingly, the first observer 130 may only report that the drone 120 is currently in the downtown area and appears to be near a building 190. The first observer 130 also reports that the drone 120 is travelling westbound toward her current location, which she may provide by simply submitting the GPS location as determined by her mobile phone and/or by providing the address of the building 180.

Meanwhile, the second observer 150 may be standing a few blocks away near building 195. The second observer 150 did not see the direction that the drone 120 came from, but the second observer 150 currently has an unobstructed line of sight to the current location of the drone 120. Using his mobile phone or device 170, the second observer 150 takes a photo of the drone 120 and uploads the photo to the processing system 200. Finally, the third observer 140 is standing next to building 190 and is directly underneath the drone 120. However, because of his proximity to the building 190, the third observer 140 cannot obtain a clear image of the drone 120. Instead, the third observer 140 submits information regarding his current location, which may include the address of the building 190 or GPS coordinates obtained from his mobile device (not shown), and the time of day of the sighting. In addition, because of his proximity to the drone 120, the third observer 140 is also able to identify a logo on the drone 120 and submits the logo information to the processing system 200. The third observer 140 also sees the drone 120 traveling westbound toward building 180.

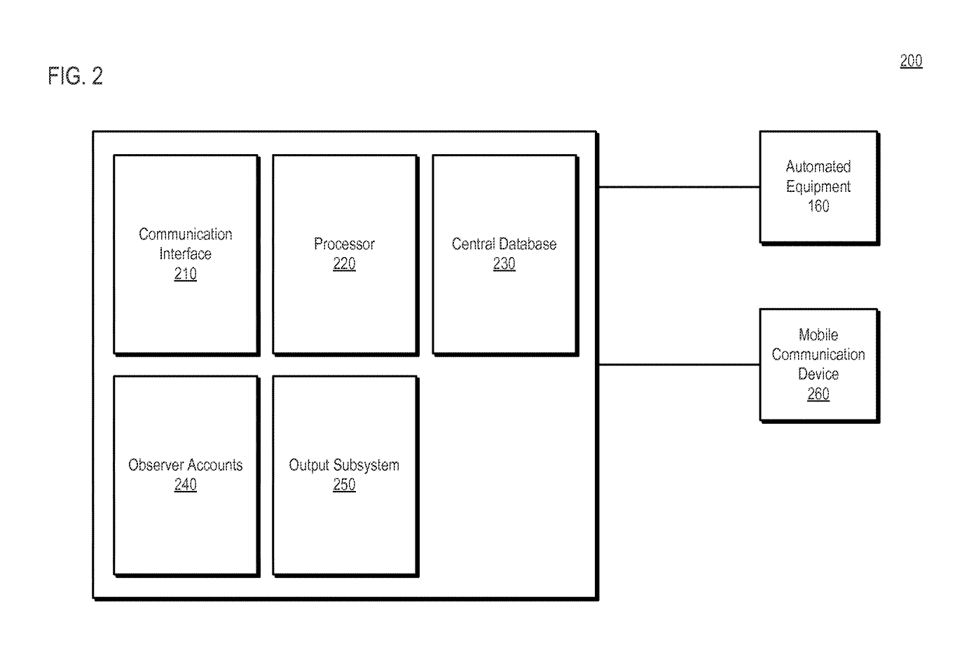

In some embodiments, the processing system 200 may also receive additional information from automated equipment or devices 160 that may be positioned at various locations in the outdoor environment. For example, the equipment 160 may include telescopes, surveillance cameras, weather equipment, satellites, lidar/radar sensors, and laser rangefinders mounted to or attached to a building. The equipment 160 may provide a range of information that may be difficult for an observer to provide, such as accurate details regarding a speed of the drone 120, or may capture still photographs over a period of time to provide more details regarding a traveled flight path of the drone 120. Depending on the nature of the equipment 160, the equipment 160 may provide images, acoustic recordings, laser reflections, radio frequency measurements, LIDAR measurements, and/or radar measurements. With the reports received from the observers 130, 140, 150 and the equipment 160, the processing system 200 may determine various characteristics and information relating to the drone. For example, the processing system 200 may identify the drone 120, determine a precise location of the drone 120, determine a previous flight path of the drone 120, and project a future flight of the drone 120. Additional details regarding the processing system 200 are discussed in further detail below with respect to FIG. 2.

FIG. 2 is a schematic diagram of a processing system 200 for receiving measurements and observations from a plurality of observers 130, 140, 150 and equipment 160 to locate and track the drone 120. With reference to FIG. 2, the processing system 200 includes a communication interface 210 configured to receive observations and measurements of the location of the drone 120 from the observers 130, 140, 150 and/or the automated equipment 160. The measurements may include any of various types and categories of information, such as: images, acoustic readings, laser reflections, radio frequency measurements, LIDAR and radar measurements, a speed, velocity, and/or a range and direction of motion of the drone 120 relative to a location of the observer 130, 140, 150 or equipment 160.

In addition, the observations may include human observations, such as: oral reports, typed or written reports, submitted responses to questions in a report form, and/or a selection made by the observer of one or more images or silhouettes that closely matches the observed drone 120. In other embodiments, the observations and/or measurements may include human-assisted measurements, such as: images captured by a human-aimed wireless communication device (e.g., a mobile phone or a tablet), and a measurement processed by a user, including information isolated from the measurement (e.g., selecting a portion of an image or an acoustic spectrum selected by the observer). In still other embodiments, the human observations may include high-level information provided by the human observers 130, 140, 150, such as: a vehicle type, a vehicle size, a license number and/or registration number of the drone 120, a speed, an altitude, and a range of the drone 120, observation time, and a street name and a street number (or other address information) at which the drone 120 is located.

In some embodiments, the communication interface 210 may receive the measurements and observations directly from a wireless communication device that obtains the measurements and observations. For example, the communication interface 210 may receive images or other data wirelessly transmitted directly from the equipment 160, such as a satellite or traffic camera. In other embodiments, the communication interface 210 may receive the measurements and/or observations from a computer network (such as via an observer's home computer or laptop), a wireless communication device network, such as a mobile phone network, or other suitable network.

Preferably, the communication interface 210 receives information in addition to the measurements and observation reports from the observers 130, 140, 150. For example, the communication interface 210 may also receive ancillary data, which may comprise a wide range of information that may or may not relate specifically to the drone 120. For example, in one embodiment, the ancillary data may include an image, a spectral signature, a size, and/or a shape of the drone 120, which may help in identifying the drone 120. In other embodiments, the ancillary data may include information relating specifically to the observers 130, 140, 150 providing the report. This data may help the processing system 200 assess the credibility and accuracy of the report. For example, the ancillary data may include identifiers and information relating to the observers 130, 140, 150 making the measurements, such as a name and a location of the observer, a history of the observer's observations, reliability of previous observations, and other suitable data.

In other embodiments, the ancillary data may relate specifically to conditions and information about the measurements and observations. For example, the ancillary data may include any of the following: (a) a time and day at which the measurements and observations were performed by the observer 130, 140, 150 and/or the equipment 160; (b) observing conditions, such as visibility, weather patterns, and lighting conditions; (c) an assessment of the location accuracy; (d) an estimate of measurement uncertainty; and (e) a location and/or a directional orientation from which the measurements were made. The location and/or direction orientation information may be taken from any one of a variety of sources. For example, in some embodiments, the location may be obtained from a map, or from a satellite navigation system (e.g., via the observer's mobile phone, computer, or other device used to submit the report), or from nearby transmitters located by the observer's position from which the measurements were sent to the communication interface 210, or based on geographic landmarks or dead reckoning. In some embodiments the sensor (e.g., radar sensor, camera, cell phone) may include sensors such as motor encoders, gyroscopes, or accelerometer arrays to determine its pointing direction, and may automatically provide this orientation information to the communication interface 210.

In still other embodiments, the ancillary data may include a sensor identifier and/or a sensor type relating to the sensor that was used to make the observation. For example, if a satellite submitted photographs of the drone 120, the ancillary data may a satellite as being the sensor type, and may include additional information about the satellite, such as a serial number, a model number, its location and directional orientation, and other suitable data. To identify the sensor identifier and sensor type information, the processor 220 may be configured to access a database to determine the information associated with the sensor identifier.

With reference to FIG. 2, the processing system 200 further includes a processor 220 that may be part of a central server (e.g., a cloud server), a wireless communication device, or a computer terminal. As mentioned previously, the processing system 200 may be configured to track and store information relating to a plurality of individual drones 120, with the processor 220 being configured to store location information for all or a particular set of drones 120. The set of drones 120 may be all the drones that are in a particular area or region, or may be a subset of drones 120 of particular interest, such as commercial drones belonging to a particular business sector, personal-use drones, drones made by a particular manufacture or set of manufacturers, and/or drones meeting specific size, shape, and speed criteria.

Upon receiving measurements and observation data from the observers 130, 140, 150 via the communication interface 210, the processor 220 analyzes the data and identifies whether the observed drone 120 is a member of the set of drones 120 that is being tracked by the processing system 200. If the processor 220 determines that the drone 120 is a member of the set of drones, the processor 220 associates the measurements and observations with the respective drone 120. As is further explained in detail below, the processor 220 may determine whether the measurements and observations are associated with a selected drone 120 based on an analysis of the measurements/observations received, which may be compared with the stored location information for the monitored set of vehicles. The processor 220 may determine whether the received information is associated with a selected drone 120 in a variety of ways, such as: (1) based on an appearance or size of a target, which may be determined via images that the processor 220 may receive of the target drone 120; (2) based on a sound received from the target; (3) based on a flight direction of the target; (4) based on a previous travel path (e.g., a travel path on a current or previous date) or travel history of known drones; (5) based on permitted vehicle travel paths or flight corridors; and/or (6) based on a kinematic feasibility, such as whether the target is close in proximity to a location of a known drone 120 reported at approximately the same time, or whether the target is close or on a known or predicted flight path of a drone 120. In some embodiments, if the processor 220 determines that the drone 120 is not a member of the monitored set of drones, then the processor 220 may create a new entry to add the drone 120 to the stored set of drones.

In addition to determining whether the measurements and observations are associated with a particular drone 120, the processor 220 is further configured to compute a location of the drone 120 based on the measurements and observations collected from the observers 130, 140, 150 and/or the equipment 160 as described previously with reference to FIG. 1. In some embodiments, the location may comprise a three-dimensional geographical location, a two-dimensional location (such as latitude-longitude coordinates, or a position on a map), and/or a one-dimensional location along a one-dimensional path, such as a road or a river.

Preferably, the processor 220 is configured to compute the location of the drone 120 by combining measurements and/or observations from two or more different observers 130, 140, 150, including the equipment 160, to help reduce uncertainty and improve accuracy. For example, the processor 220 may combine an observation report from the first observer 130 with a measurement report from the camera 160 to locate the drone 120. In some embodiments, the processor 220 may combine angle information from two or more observers to compute a range or combine range information to compute an angle. The processor 220 may also filter the information to improve accuracy, such as by combining measurements and/or observations from two or more observers with at least one of a least-squares filter, a Kalman filter, and a nonlinear filter.

In other embodiments, the processor 220 may further compute the location of the drone 120 based on the measurements, observations, and general information that may be associated with drones 120 (or another vehicle being tracked). For example, with reference to a drone, the general information may include permitted vehicle flight corridors, vehicle model specifications (such as maximum speed, fuel capacity, maximum flight distance), a published schedule, a filed flight plan or logs, road locations, and ground terrain (such as vegetation, slope, mountainside, etc.). The general information may be analyzed by the processor 220 to assess the measurements, expedite tracking, and increase the location accuracy of the drones 120. For example, if a drone 120 is located within a first set of geographic coordinates as reported by observers 130, 140, 150, the processor 220 may access information related to permitted flight corridors near the reported geographic coordinates. The permitted flight corridors may contain information restricting vehicle flight paths to within a particular airspace near the reported coordinates. With this information, the processor 220 may identify a route that the drone 120 likely flew before being observed (assuming the drone 120 respected the permitted flight corridors), and may predict a future route based on permitted flight corridors.

In other embodiments, the processor 220 may further compute the location of the drone 120 based on the measurements, observations, and historical information that may be associated with a particular drone 120 or a set of drones 120 (or another vehicle being tracked). The historical information may include information relating to a previously observed vehicle schedule or route of the particular drone 120. The historical information associated with the drone 120 may be used to determine whether the drone 120 has a recurring or varied flight path. In other embodiments, the previous schedule may be used to predict a travel route of the drone 120. For example, when a first group of observers 130, 140, 150 reports a first location of the drone 120 within an airspace and travel direction, the processor 220 may determine whether the drone location is associated with a previously observed route. If the location falls within a previous route, the processor 220 may predict that the drone's 120 future route will be the same as a previously observed route. At a later time, a second group of observers (not shown) may report a second location of the drone 120, and the processor 220 may determine that the second location also falls within the previous route. Based on the observations and measurements from the first group of observers 130, 140, 150, and the second group of observers, and the previous flight schedule, the processor 220 may predict the past and future route of the drone 120 with high accuracy.

In other embodiments, the historical information may be related specifically to the observer (e.g., observers 130, 140, 150) providing the observation and/or measurement report. For example, the historical information may include observer reliability, observer accuracy, and observer history of providing false or spoofed reports. The processor 220 may use this information to determine whether to rely more heavily on particular reports (based on high reliability of an observer) or discredit/ignore other reports (based on high fallacy rates of the observer). The observer information may be useful to help the processor 220 accurately locate a drone 120 by relying primarily on the reports of the most reliable observers. This procedure may be particularly helpful in dissecting reports that may be conflicting.

In some embodiments, the processing system 200 may further include a storage medium or a central database 230 to store the measurements and observations received from the plurality of observers 130, 140, 150 via the communication interface 210 and to store other data, such as the historical information, ancillary data, vehicle-specific data, and other suitable information. As is explained in further detail below, the storage medium may further include a plurality of observer profiles stored therein where each of the profiles includes data relating to the observers (e.g., identity, report history, reliability, etc.). The observer files may also be linked to observer accounts 240 that may store reward information for each of the observers. Additional details regarding reward information and observer accounts 240 are described in further detail below. In some embodiments, the central database 230 may comprise any file server or other suitable storage system, including cloud storage.

Preferably, the processor 220 has unlimited access rights to the central database 230 (or other database) to access any and all measurement data compiled for the drones 120, and perhaps other data, such as information relating to the plurality of observers, 130,140, 150, such as identity and reliability information as described previously. In other embodiments, the processor 220 may have more limited access rights to only a portion of the database 230, such as access to the vehicle measurements but no access to observer account information, or may have limited rights based on a location and/or an access status of the processor 220.

In some embodiments, once the processor 220 has determined a location of the drone 120 based on the measurements and observations, the processing system 200 may be accessible by the public to obtain information relating to drone location. For example, in one embodiment, the communication interface 210 may receive a request for the location of the drone 120 and provide the location to a wired or wireless communication device 260, such as a user's mobile phone, tablet, computer, or other suitable device via an output system 250. The communication interface 210 may also receive requests from wired or wireless devices to perform different measurements. For example, a user may access the communication interface 210 (e.g., by logging on to a website) via a mobile phone and request confirmation of a drone path, or identification/location information of a specific drone 120. In response, the communication interface 210 or the output system 250 may wirelessly transmit the drone path or identity of a specific drone 120 to the user.

In other embodiments, the communication interface 210 may be in communication with the equipment 160 and configured to operate the equipment 160 to help capture data from the drone 120. For example, the communication interface 210 may be configured to receive a request to aim a sensor, such as equipment 160, in an indicated direction to capture data from a drone 120 or other vehicle traveling near the sensor. Upon receiving the request, the communication interface 210 may transmit a request to position the sensor to aim in the indicated direction. For example, with reference to FIG. 1, one or more of the observers 130, 140, 150 may identify a drone 120 flying near building 195 and the first observer 130 may send a request to the communication interface 210 to aim equipment 160 in the direction of the drone 120. Upon receiving the request, the communication interface 210 may send a request to aim the equipment 160 in the proper direction to obtain images of the drone 120.

In some embodiments, the processing system 200 may be configured to incentivize observers 130, 140, 150 to continue submitting accurate measurement reports and observations relating to the drones 120. The processing system 200 may include an observer account 240 associated with each individual observer 130, 140, 150. In exchange for receiving observations and measurements from the observers 130, 140, 150, or responding to a query about the drones 120, the processing system 200 may track responses and provide a reward to the observer accounts 240. The rewards may include money, lottery entry, notoriety, praise, public acknowledgement, awards, and other suitable rewards. In some embodiments, the reward may be provided based on the quality of the observation and measurement. For example, an observer that submits photos, a description, and GPS location for the drone 120 may receive a larger reward (e.g., more money) than an observer that submits just a description of the drone 120 with no other information.

In some embodiments, communication interface 210 may send a request to one or more potential observers 130, 140, 150 for information concerning vehicles/drones 120 in their vicinity. Such a request may be triggered by a prediction that a vehicle 120 is in their vicinity, by one or more received observations of a nearby vehicle, to differentiate between a number of possible vehicle routes, or the like. The request may be sent only to potential observers 130, 140, 150 within a specified space/time region, or it may be sent to: (1) a large set of such potential observers 130, 140, 150; (2) to a subset who have provided observations in the past; and/or (3) to owners of specified sensors (cameras, cell phones, etc.). Such a request may be accompanied by an offer of rewards or other incentives.

In other embodiments, the reward may be provided based on a total tally of reports submitted, such as for satisfying a minimum quota of observations made during a specified time period (e.g., ten observations per month), or on an importance of the observation, such as observing and providing information for a high value drone 120. In still other embodiments, the reward may be provided to observers that provide missing information relating to a drone 120. For example, multiple observers may submit location information relating to a drone 120, but no images or photos have been submitted. If a subsequent observer captures and submits an image of the drone 120, the processing system 200 may provide a reward or may increase the reward for the missing information.

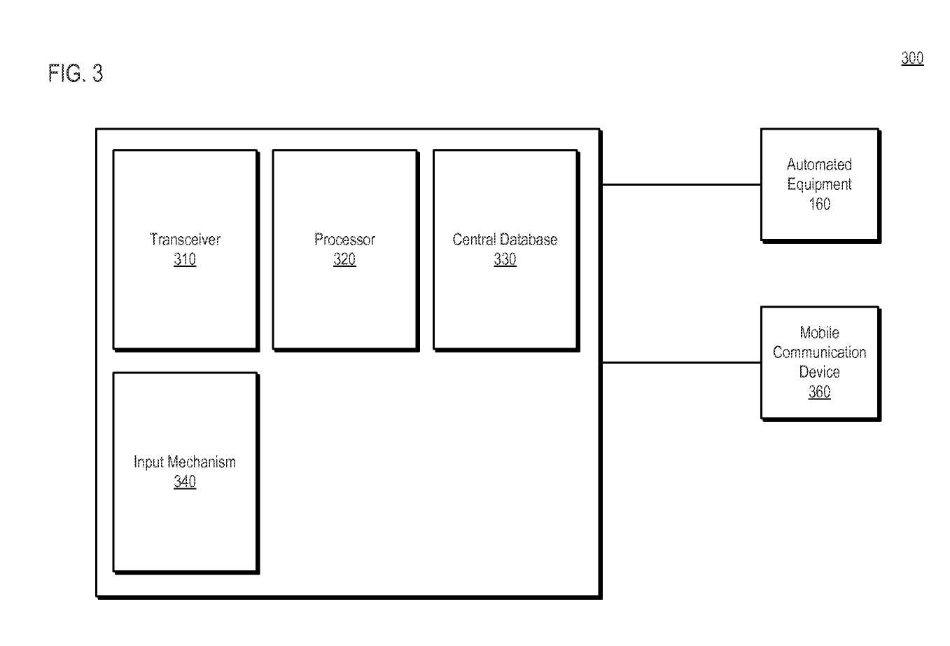

FIG. 3 illustrates an alternative embodiment for a system of tracking vehicles, which may include many of the same or similar components as the processing system 200. Accordingly, to avoid unnecessarily repeating the description for structure and function of certain components, reference numbers in the 300-series having the same final two digits as those in FIG. 2 are used in FIG. 3 to identify analogous structures. For example, it should be understood that processor 320 as described with reference to FIG. 3 may be identical to and capable of carrying out the same calculations and protocols as processor 220 of FIG. 2. Accordingly, some detail of these structures may not be further described to avoid obscuring more pertinent aspects of the embodiments. Instead, the following discussion focuses more on certain differences and additional features of these and other components of a wireless communication device 300 described in FIG. 3.

With reference to FIG. 3, the wireless communication device 300 includes a transceiver 310 configured to receive measurements and human observations relating to vehicle locations from the independent observers 130, 140, 150 and equipment 160 to locate and track the drone 120. The measurements and observations may include a variety of information, such as, for example, speed, velocity, acceleration, and/or a range and direction of motion of the drone 120 relative to a location of the observer 130, 140, 150 and/or equipment 160. The transceiver 310 may receive other information in addition to the measurements and observations submitted by the observers 130, 140, 150 and/or equipment 160, such as ancillary data, general information, and historical vehicle information as described previously with respect to the communication interface 210 of FIG. 2.

The wireless communication device 300 includes a processor 320 configured to associate measurements and observations with a selected vehicle and compute a location of the selected vehicle based on the measurements and observations. The processor 320 may also perform additional calculations, such as determining a prior and future route of the selected vehicle, determining a future location of the vehicle, and other calculations described previously with reference to processor 220 of FIG. 2. The system further includes a central database 330, such as cloud storage for a plurality of observers 130, 140, 150 from which the transceiver 310 may receive the measurements and observations, along with the ancillary data, the historical information, the general information, and other information that may be used to determine the location of the drone 120. In some embodiments, after the processor 320 determines a location and other information relating to the drone 120, the transceiver may provide, push or otherwise transmit the location and other vehicle information to a mobile communication device 360, such as a user's mobile phone, computer, or other device.

In some embodiments, the wireless communication device includes an input mechanism 340 to receive measurements and observations from the observers 130, 140, 150. For example, in some embodiments, the input mechanism 340 may be a microphone for receiving oral reports and observations. In other embodiments, the input mechanism 340 may be a keyboard for receiving typed observations or a touchscreen for receiving input from the observers 130, 140, 150.

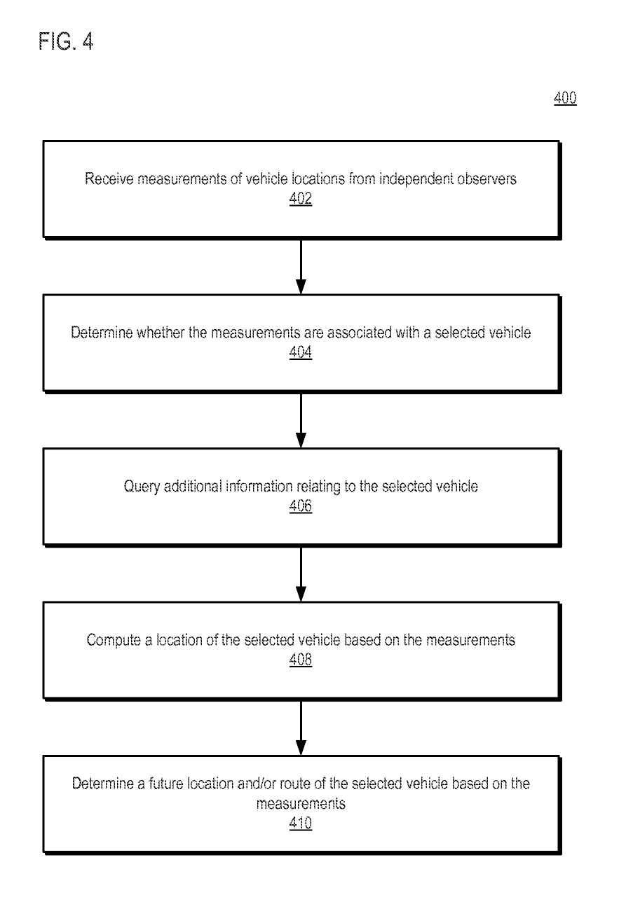

FIG. 4 is a flow diagram of a method 400 for determining the location of a vehicle, such as a drone 120, based on information received from one or more observers 130, 140, 150 and/or equipment 160. It should be understood that the method described below is for illustration purposes and the order in which the steps are described is not meant to be limiting. In addition, it should be understood that in other embodiments, the steps may occur in a different order. Moreover, certain features and capabilities of the processor described previously with respect to FIGS. 1-3 may not be described fully with respect to FIG. 4 to avoid repetition. It is intended that any features and capabilities previously described with respect to the processor are also embodied in the method 400.

With particular reference to FIG. 4, at step 402, the processor receives measurements of vehicle locations from a plurality of independent observers (including both human observers and automated equipment). As described previously with respect to FIGS. 1-3, the measurements may include a variety of information reported by the independent observers, such as, for example an identity of the vehicle, velocity and direction of motion, acceleration, and images of the vehicle.

At step 404, the processor determines whether the measurements are associated with a particular or selected vehicle. Upon receiving the information, the processor may query a central database or other storage medium and determine if the reported measurements match or complement any information that the processing system may already have stored for any one of a variety of vehicles. If the measurements are associated with a vehicle, the processor may, at step 406, query additional information relating to the vehicle from the central database or other storage medium. If the measurements are not associated with any vehicle, the processor may update the stored set of vehicles to include tracking information for the new vehicle.

At step 408, the processor computes a location of the selected vehicle based on the measurements received and/or any measurements previously stored in the central database. In some embodiments, at step 410, the processor may determine a future location and/or a route of the selected vehicle based on the measurements.

As mentioned previously, the method 400 may include additional steps and the processor may be configured to perform various other functions, such as those described with respect to FIGS. 1-3. In addition, in other embodiments, the method 400 may be embodied in machine-executable instructions to be executed by a computer system, which may include one or more general-purpose or special-purpose computers (or other electronic devices). The computer system may include hardware components that include specific logic for performing the steps or may include a combination of hardware, software, and/or firmware.

Embodiments may also be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD ROMs, DVD ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. Suitable networks for configuration and/or use as described herein include one or more local area networks, wide area networks, metropolitan area networks, and/or “Internet” or IP networks, such as the World Wide Web, a private Internet, a secure Internet, a value-added network, a virtual private network, an extranet, an intranet, or even standalone machines which communicate with other machines by physical transport of media (a so-called “sneakernet”). In particular, a suitable network may be formed from parts or entireties of two or more other networks, including networks using disparate hardware and network communication technologies.

One suitable network includes a server and several clients; other suitable networks may contain other combinations of servers, clients, and/or peer-to-peer nodes, and a given computer system may function both as a client and as a server. Each network includes at least two computers or computer systems, such as the server and/or clients. A computer system may include a workstation, laptop computer, disconnectable mobile computer, server, mainframe, cluster, so-called “network computer” or “thin client,” tablet, smart phone, personal digital assistant or other hand-held computing device, “smart” consumer electronics device or appliance, medical device, or a combination thereof.

The network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, radio waves, satellites, microwave relays, modulated AC power lines, physical media transfer, and/or other data transmission “wires” known to those of skill in the art. The network may encompass smaller networks and/or be connectable to other networks through a gateway or similar mechanism.

Each computer system includes at least a processor and a memory; computer systems may also include various input devices and/or output devices. The processor may include a general purpose device, such as an Intel®, AMD®, or other “off-the-shelf” microprocessor. The processor may include a special purpose processing device, such as an ASIC, SoC, SiP, FPGA, PAL, PLA, FPLA, PLD, or other customized or programmable device. The memory may include static RAM, dynamic RAM, flash memory, one or more flip-flops, ROM, CD-ROM, disk, tape, magnetic, optical, or other computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The computer systems may be capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices. The physical configuration represents data and instructions which cause the computer system to operate in a specific and predefined manner as described herein.

Suitable software to assist in implementing the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Several aspects of the embodiments described may be illustrated as software modules or components. As used herein, a software module or component may include any type of computer instruction or computer executable code located within a memory device. A software module may, for instance, include one or more physical or logical blocks of computer instructions, which may be organized as a routine, program, object, component, data structure, etc., that perform one or more tasks or implement particular abstract data types.

In certain embodiments, a particular software module may include disparate instructions stored in different locations of a memory device, different memory devices, or different computers, which together implement the described functionality of the module. Indeed, a module may include a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Much of the infrastructure that can be used according to the present invention is already available, such as: general purpose computers; computer programming tools and techniques; computer networks and networking technologies; digital storage media; authentication; access control; and other security tools and techniques provided by public keys, encryption, firewalls, and/or other means.

Other embodiments are possible. Although the description above contains much specificity, these details should not be construed as limiting the scope of the invention, but as merely providing illustrations of some embodiments of the invention. As noted previously, details described with particular reference to the processing system 200 of FIGS. 1 and 2 may not have been described with respect to the wireless communication device 300 of FIG. 3. In addition, details described with particular reference to the processing system 200 of FIGS. 1 and 2 may not have been described specifically with respect to the method 400 of FIG. 4. However, it should be understood that subject matter disclosed in one portion herein can be combined with the subject matter of one or more of other portions herein as long as such combinations are not mutually exclusive or inoperable.

The terms and descriptions used above are set forth by way of illustration only and are not meant as limitations. Those skilled in the art will recognize that many variations can be made to the details of the above-described embodiments without departing from the underlying principles of the invention.

1. A system for tracking vehicles, the system comprising:
a communication interface configured to receive measurements of vehicle locations from a plurality of independent observers; and
a processor configured to:
determine the received measurements are associated with a selected vehicle; and
compute a location of the selected vehicle based on the measurements.

2. (canceled)

3. The system of claim 1, wherein the processor is configured to determine a route of the selected vehicle based on the measurements.

4. The system of claim 1, wherein the processor is configured to predict a future location of the selected vehicle based on the measurements.

5-9. (canceled)

10. The system of claim 1, wherein the processor is further configured to store location information for a set of vehicles, wherein the processor is configured to determine the measurements associated with the selected vehicle based on the measurements and the stored location information for the set of vehicles, and wherein the processor is further configured to identify the selected vehicle as a member of the set of vehicles.

11. The system of claim 1, wherein the processor is further configured to store location information for a set of vehicles, wherein the processor is configured to determine the measurements associated with the selected vehicle based on the measurements and the stored location information for the set of vehicles, and wherein the processor is further configured to update the set of vehicles by adding the selected vehicle to the set of vehicles when the processor identifies the selected vehicle as not being a member of the set of vehicles.

12-19. (canceled)

20. The system of claim 1, wherein the communication interface is configured to receive the measurements from a network selected from the group consisting of a computer network and a wireless communication device network.

21-29. (canceled)

30. The system of claim 1, wherein the communication interface is configured to receive ancillary data associated with the measurements, and wherein the ancillary data includes at least one of an image, a spectral signature, an identity, a size, and a shape of the vehicle.

31-41. (canceled)

42. The system of claim 1, wherein the communication interface is configured to receive ancillary data associated with the measurements, and wherein the ancillary data includes identifiers for observers making the measurements.

43-46. (canceled)

47. The system of claim 1, wherein the processor is configured to compute the location based on the measurements and general information.

48-53. (canceled)

54. The system of claim 1, wherein the processor is configured to compute the location based on the measurements and historical information.

55-60. (canceled)

61. The system of claim 1, wherein the processor has access rights to an entire database of measurements.

62-65. (canceled)

66. The system of claim 1, wherein the communication interface is configured to provide the location to a wireless communication device.

67. The system of claim 1, wherein the communication interface is configured to receive a request to perform a measurement.

68-72. (canceled)

73. The system of claim 1, wherein the communication interface is configured to transmit a request to perform a measurement to at least one observer.

74-95. (canceled)

96. The system of claim 1, wherein the processor is further configured to provide a reward to an account associated with an observer providing one of the received measurements.

97-106. (canceled)

107. A non-transitory computer readable storage medium comprising program code configured to cause a processor to perform a method for tracking vehicles, the method comprising:
receiving measurements of vehicle locations from a plurality of independent observers;
determining the measurements are associated with a selected vehicle; and
computing a location of the selected vehicle based on the measurements.

108. (canceled)

109. The non-transitory computer readable storage medium of claim 107, further comprising determining a route of the selected vehicle based on the measurements.

110. The non-transitory computer readable storage medium of claim 107, further comprising predicting a future location of the selected vehicle based on the measurements.

111-114. (canceled)

115. The non-transitory computer readable storage medium of claim 107, further comprising storing location information for a set of vehicles, and wherein determining the measurements associated with the selected vehicle is based on the measurements and the stored location information for the set of vehicles.

116-128. (canceled)

129. The non-transitory computer readable storage medium of claim 107, further comprising storing the received measurements in a central database, and further comprising storing ancillary data associated with the measurements in the central database.

130-135. (canceled)

136. The non-transitory computer readable storage medium of claim 107, further comprising receiving ancillary data associated with the measurements, and wherein the ancillary data includes at least one of an image, a spectral signature, an identity, a size, and a shape of the vehicle.

137. The non-transitory computer readable storage medium of claim 107, further comprising receiving ancillary data associated with the measurements, and wherein the ancillary data includes times at which the measurements were performed.

138-147. (canceled)

148. The non-transitory computer readable storage medium of claim 107, further comprising receiving ancillary data associated with the measurements, and wherein the ancillary data includes identifiers for observers making the measurements.

149-152. (canceled)

153. The non-transitory computer readable storage medium of claim 107, wherein computing the location comprises computing the location based on the measurements and general information.

154-159. (canceled)

160. The non-transitory computer readable storage medium of claim 107, wherein computing the location comprises computing the location based on the measurements and historical information.

161-184. (canceled)

185. The non-transitory computer readable storage medium of claim 107, wherein computing the location comprises combining measurements from two or more different observers.

186-201. (canceled)

202. The non-transitory computer readable storage medium of claim 107, wherein the method further comprises providing a reward to an account associated with an observer providing one of the received measurements.

203-212. (canceled)

213. A wireless communication device for tracking vehicles, the device comprising:
a transceiver configured to receive measurements of vehicle locations from a plurality of independent observers; and
a processor configured to:
determine measurements associated with a selected vehicle; and
compute a location of the selected vehicle based on the measurements.

214. (canceled)

215. The device of claim 213, wherein the processor is configured to determine a route of the selected vehicle based on the measurements.

216-248. (canceled)

249. The device of claim 213, wherein the transceiver is configured to receive ancillary data associated with the measurements, and wherein the ancillary data includes identifiers for observers making the measurements.

250-252. (canceled)

253. The device of claim 213, wherein the transceiver is configured to receive ancillary data associated with the measurements, wherein the ancillary data includes observing conditions, and wherein the observing conditions include a condition selected from the group consisting of visibility, weather, and lighting.

254-271. (canceled)

272. The device of claim 213, wherein the transceiver is configured to receive a request to perform a measurement.

273. The device of claim 272, wherein the transceiver is configured to receive a request to confirm a vehicle path, and wherein the transceiver is configured to receive a request to identify a specific vehicle.

274-276. (canceled)

277. The device of claim 272, wherein the transceiver is configured to receive a request to aim a sensor in an indicated direction.

278. The device of claim 213, wherein the transceiver is configured to transmit a request to perform a measurement to at least one observer.

279. The device of claim 278, wherein the transceiver is configured to transmit a request to confirm a vehicle path, and wherein the transceiver is configured to transmit a request to identify a specific vehicle.

280-282. (canceled)

283. The device of claim 278, wherein the transceiver is configured to transmit a request to aim a sensor in an indicated direction.

284-300. (canceled)
